(19) United States
(12) Patent Application Publication
(10) Pub. No.: US 2012/0102242 A1
(43) Pub. Date: Apr. 26, 2012

(54) CONTROLLING DATA DESTAGING WITHIN A MULTI-TIERED STORAGE SYSTEM

(75) Inventors: Benny Koren, Zikhron Ya'aqov (IL); Shachar Fienblit, Ein Ayala (IL); Guy Keren, Haifa (IL); Eyal Gordon, Haifa (IL); Eyal David, Kiryat Tivon (IL)

(73) Assignee: KAMINARIO TECHNOLOGIES LTD., Yokne'am ILIT (IL)

(21) Appl. No.: 12/911,975

(22) Filed: Oct. 26, 2010

(51) Int. Cl. G06F 13/10

(52) U.S. Cl. 710/36

(57) ABSTRACT

There is provided according to an example of the claimed subject matter, a system and a method for managing access to a shared storage entity. According to an example of the claimed subject matter, a system for managing access to a shared storage entity can include two or more initiator entities, two or more local sequencing agents and an arbitration module. Each of the two or more local sequencing agents can be associated with a respective one of two or more initiator entities which generate I/O requests for accessing the shared storage entity. Each local sequencing agent can be adapted to locally sequence its respective initiator entity's I/O requests. The arbitration module can be adapted to manage an access cycle to the shared storage entity by allocating to each one of the plurality of initiator entities a monolithic/continuous chunk of the access cycle to implement its own I/O access sequence, wherein chunk allocation is determined according to subframe allocation criteria related to the functional characteristics of each of the initiator entities.

### FIELD OF THE INVENTION

The present invention is in the field of multi-tiered storage systems.

### BACKGROUND OF THE INVENTION

U.S. Pat. No. 7,216,182 to Henkel relates to an arbitration unit that is adapted for controlling accesses to a shared storage. The arbitration unit comprises a set of interfaces adapted for connecting a plurality of units with said arbitration unit, wherein outgoing data streams are transmitted from the arbitration unit via respective ones of said interfaces to at least one of said units, and wherein incoming data streams are transmitted from at least one of said units via respective ones of said interfaces to the arbitration unit. A control logic is connected to each of said interfaces, said control logic being adapted for segmenting write data of incoming data streams in order to set up write accesses to said shared storage, for scheduling a sequence of at least one of write and read accesses to said shared storage, and for distributing read data obtained during said read accesses to outgoing data streams.

International Application Publication No. WO/2010/085256 to Padala et al., discloses a system and method for allocating resources on a shared storage system. The system (10) can include a shared storage device (12) and a plurality of port schedulers (14) associated with a plurality of I/O ports (16) that are in communication with the shared storage device (12). Each port scheduler (14) is configured to enforce a concurrency level and a proportional share of storage resources of the shared storage device (12) for each application (18) utilizing the associated port. The system (10) can also include a resource controller (17) that is configured to both monitor performance characteristics of the applications (18) utilizing at least one of the I/O ports (16), and to adjust the concurrency level and the proportional share of storage resources parameters of the port schedulers (14) for at least a portion of the applications (18) in order to vary allocation of the resources of the shared storage device (12).

### SUMMARY OF THE INVENTION

There is provided according to an example of the claimed subject matter, a system and a method for managing access to a shared storage entity. According to an example of the claimed subject matter, a system for managing access to a shared storage entity can include two or more initiator entities, two or more local sequencing agents and an arbitration module. Each of the two or more local sequencing agents can be associated with a respective one of two or more initiator entities which generate I/O requests for accessing the shared storage entity. Each local sequencing agent can be adapted to locally sequence its respective initiator entity's I/O requests. The arbitration module can be adapted to manage an access cycle to the shared storage entity by allocating to each one of the plurality of initiator entities a monolithic/continuous chunk of the access cycle to implement its own I/O access sequence, wherein chunk allocation is determined according to subframe allocation criteria related to the functional characteristics of each of the initiator entities.

According to a further example of the claimed subject matter, each local sequencing agent can be adapted to sequence the respective initiator entity's I/O requests independently of the I/O requests of any of the other initiator entities.

According to yet a further example of the claimed subject matter, the allocation criteria is independent of characteristics of any specific I/O request or I/O stream.

Still further by way of example, the local sequencing agents' access sequencing procedure overrides an I/O scheduling procedure provided by an operating system associated with the shared storage entity.

Yet further by way of example, at least one of the functional entities is adapted to take into account a characteristic of the functional entity when determining the I/O scheduling during a frame allocated to the functional entity. Still further by way of example, the characteristic of the functional entity include a measure of sequentiality of I/Os associated with the respective functional entity. According to a further example, the characteristic of the functional entity can include a type of application or applications which are associated with the respective entity. According to yet a further example, the characteristic of the functional entity can include a measure of an importance of I/O streams coming from the respective entity.

According to an example of the claimed subject matter, at least one of the functional entities can be adapted to identify a group of blocks which are already stored within the NVS device and/or empty blocks which are sequentially arranged within the NVS device intermediately in-between two I/O requests which are not in sequence with one another, and the functional element can be adapted to form from the two I/O requests and the intermediate sequence a single of extended I/O request.

Still further by way of example, the controller can be adapted to determine a size of each subframe, at least according to the priority of each of the functional entities during the given system state.

According to an example of the claimed subject matter, the subframes are equal in size, and the controller can be adapted to determine a number of subframes to be allocated to each of the functional elements according to the priority of the respective functional element during the given system state. According to a further example, the controller can be responsive to an indication that the system state has changed for reallocating the subframes among the two or more functional entities according to an updated priority of the functional elements during the new system state.

According to an example of the claimed subject matter, one or more functional entities which generate a stream of I/O requests for accessing the NVS device can be added and/or removed as the system state changes, giving rise to a new set of two or more functional entities generating a stream of I/O requests for accessing the NVS device.

According to a further aspect of the claimed subject matter, there is provided a method of managing access to a shared storage entity: By way of example the method of managing access to a shared storage entity can include: obtaining data with respect to characteristics of each one of two or more initiator entities that share I/O access to the shared storage entity; defining an access cycle timeframe for accessing the shared storage entity; allocating to each one of the two or more initiators associated with the shared storage entity a continuous subframe during which the respective initiator is granted exclusive access to the shared storage entity, wherein the subframe is a continuous chunk of the access cycle timeframe; and during each subframe locally sequencing a plurality of I/O requests on a respective one of said two or more initiator entities sharing I/O access to the shared storage entity.

According to an example of the claimed subject matter, during each subframe the sequencing of I/O requests on a respective initiator entity sharing I/O access to the shared storage entity can be done independently of a sequencing on any one of the other initiators sharing access to the shared storage entity.

According to a further aspect of the claimed subject matter, there is provided a program storage device readable by machine, tangibly embodying a program of instructions executable by the machine to perform a method of managing access to a shared storage entity, comprising: obtaining data with respect to characteristics of each one of two or more initiator entities that share I/O access to the shared storage entity; defining an access cycle timeframe for accessing the shared storage entity; allocating to each one of the two or more initiators associated with the shared storage entity a continuous subframe during which the respective initiator is granted exclusive access to the shared storage entity, wherein the subframe is a continuous chunk of the access cycle timeframe; and during each subframe locally sequencing a plurality of I/O requests on a respective one of said two or more initiator entities sharing I/O access to the shared storage entity.

According to a further aspect of the claimed subject matter, there is provided a computer program product comprising a computer useable medium having computer readable program code embodied therein of managing access to a shared storage entity, the computer program product comprising: computer readable program code for causing the computer to obtain data with respect to characteristics of each one of two or more initiator entities that share I/O access to the shared storage entity; computer readable program code for causing the computer to define an access cycle timeframe for accessing the shared storage entity; computer readable program code for causing the computer to allocate to each one of the two or more initiators associated with the shared storage entity a continuous subframe during which the respective initiator is granted exclusive access to the shared storage entity, wherein the subframe is a continuous chunk of the access cycle timeframe; and computer readable program code for causing the computer to locally sequence during each subframe a plurality of I/O requests on a respective one of said two or more initiator entities sharing I/O access to the shared storage entity.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a is a block diagram illustration of a mass storage system including a system for managing access to a shared storage entity, according to some embodiments of the present invention;

FIG. 2A is a graphical illustration of an access cycle timeframe management procedure implemented with respect to the shared storage resource of the storage system shown in FIG. 1, according to some embodiments of the present invention;

FIG. 2B is a graphical illustration of the implementation by a primary storage entity of the method of forming an extended flush sequences during the access cycle of FIG. 2A, according to some embodiments of the present invention

FIG. 3 is an illustration of a dynamic access cycle timeframe allocation scheme, shown as an alternative of the rigid timeframe allocation scheme in FIG. 2B, in accordance with some embodiments; and

FIG. 4 is an illustration of dynamic management of an access cycle timeframe duration, as an alternative to the dynamic access cycle timeframe allocation scheme of FIG. 2B, according to the present subject matter.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as not to obscure the present invention.

Unless specifically stated otherwise, as apparent from the following discussions, it is appreciated that throughout the specification discussions utilizing terms such as “processing”, “computing”, “calculating”, “determining”, “assigning”, “allocating”, “accessing”, “overriding”, “updating”, “managing”, “sequencing”, “generating”, “scheduling”, “identifying”, “defining”, “granting”, “obtaining”, “causing”, “mapping”, “provisioning”, “recording”, “optimizing” or the like, refer to the action and/or processes of a computer that manipulate and/or transform data into other data, said data represented as physical, e.g. such as electronic, quantities stored within non-transitive medium. The term “computer” should be expansively construed to cover any kind of electronic device with non-transitive data recordation and data processing capabilities, including, by way of non-limiting example, personal computers, servers, computing system, communication devices, processors (e.g. digital signal processor (DSP), microcontrollers, field programmable gate array (FPGA), application specific integrated circuit (ASIC, etc.) and other electronic computing devices. Non-transitive storage or recordation of data as used herein includes storage of data within a volatile storage medium utilized in combination with Uninterruptible Power Supply (“UPS”), destaging logic, and backup non-volatile storage—to persistently store data thereon, as will be described in further detail below.

The operations in accordance with the teachings herein may be performed by a computer specially constructed for the desired purposes or by a general purpose computer specially configured for the desired purpose by a computer program non-transitively stored in a computer readable storage medium.

In addition, embodiments of the present invention are not described with reference to any particular programming language. It will be appreciated that a variety of programming languages may be used to implement the teachings of the invention as described herein.

Throughout the description of the present invention, reference is made to the term “non-solid-state storage devices” and to the abbreviation “NSSDs”. Unless specifically stated otherwise, the terms “non-solid-state storage devices”, “NSSDs” and the like shall be used to describe a component which includes one or more data-retention modules which utilize some moving mechanical component in its operation. Non-limiting examples of non-solid-state storage devices include: hard disk drive, hybrid hard drive, holographic data storage, tape drive, optical disk, Compact Disk, Digital Versatile Disc, Bluray disc, floppy Disk, micro-electro-mechanical-system (“MEMS”) based storage unit.

Throughout the description of the present invention, reference is made to the term “solid-state data retention devices” or to the abbreviation “SSDRDs”. Unless specifically stated otherwise, the terms “solid-state data retention devices”, “SSDRDs” and the like shall be used to describe a component or a collection of components that include one or more solid-state data retention units, which independently or in cooperation with other components, is/are capable of persistently storing data thereon. For clarity, it would be appreciated that in some embodiments of the present invention, a SSDRD may include one or more non-volatile data retention units and/or one or more volatile data retention units—the use of which in combination with other components and logic for storing data is described in greater detail below.

Throughout the description of the present invention, reference is made to the term “volatile storage” module or unit and to the abbreviation “VS”. These terms are usually related to a component of a storage system whose storage capability is characterized by being “volatile”. Terms used herein to describe such volatile components include “volatile storage unit”, “volatile storage device”, “volatile data-retention unit”, and the like. Unless specifically stated otherwise, the terms “volatile storage unit”, “volatile storage device”, “volatile data-retention unit”, and the like, shall be used interchangeably to describe a component which includes one or more data-retention modules whose storage capabilities depend upon sustained power. Non-limiting examples of devices which may be used as part of a volatile storage device include: random-access memory (RAM), dynamic random-access memory (DRAM), static random-access memory (SRAM), Extended Data Out DRAM (EDO DRAM), Fast Page Mode DRAM and including collections of any of the above and various combinations thereof, integrated via a common circuit board, and/or integrated via any type of computer system including, for example, using a blade server. Further details with respect to the operation of the volatile storage devices for persistently storing data shall be provided herein.

Throughout the description of the present invention, reference is made to the term “nonvolatile storage” module, unit or device or to the abbreviation “NVS” module, unit or device. Unless specifically stated otherwise, the terms “nonvolatile storage” module, unit or device and “NVS” module, unit or device and the like shall be used to describe a component which includes one or more data-retention modules that are capable of substantially permanently storing data thereon independent of sustained external power. Non-limiting examples of nonvolatile storage include: magnetic media such as a hard disk drive (HDD), FLASH memory or FLASH drives, Electrically Erasable Programmable Read-Only Memory (EEPROM), battery backed DRAM or SRAM. Non-limiting examples of a non-volatile storage module include: Hard Disk Drive (HDD), Flash Drive, and Solid-State Drive (SSD).

Throughout the description of the present invention reference is made to the term “data-set of the storage system”. The term “data-set of the storage system” is used herein to describe the aggregation of all the data that is stored within the storage system. Usually, the data-set of the storage system refers to user data and does not include system data, which is generated by the storage system as part of its operation, and is transparent from a user's perspective. In a storage system, physical storage locations are allocated by the physical storage units of the storage system, and the physical storage locations are usually mapped to logical storage addresses. The logical storage addresses are provisioned by the storage system and collectively represent the storage space provided by the storage system. When a certain data item is written to the storage system is it addressed to one or more logical storage addresses and it is stored within the storage system at the physical storage locations which are mapped to the referenced logical storage address(es). Similarly, when a read request is received at the storage system, the logical storage address(es) referenced by the request is used to determine the physical storage locations where the data item to which the read request relates is stored within the storage system. It would be appreciated that in some storage systems, several (two or more) copies of some portion or of the entire data-set of the storage system may exist. In such implementations, the data-set of the storage system includes the data that is stored in the physical storage locations that are mapped to the logical storage addresses provisioned by the storage system.

Throughout the description of the present invention reference is made to the term “data block” or “block” in short. The terms “data block” or “block” in short are known in the art and the following definition is provided for convenience purposes. Accordingly, unless stated otherwise, the definition below shall not be binding and this term should be construed in accordance with their usual and acceptable meaning in the art. The term “data block” or “block” describes a sequence of bits or bytes having a nominal length (“block size”) which together constitute the minimal chunk of data that can be addressed by the storage system. In a hierarchical storage system, such as that with which some embodiments of the present invention are associated, a different block may be defined within each tier or layer of the storage, and consequently, the block size may be varied across layers or tiers. While a block can usually only be referenced as a whole, in some implementations the actual data contained therein may constitute only a portion of the entire block.

Throughout the description of the present invention reference is made to the terms “dirty data blocks” and “dirty data”. The terms “dirty data blocks” or “dirty data” are known in the art and the following definition is provided for convenience purposes. In a storage system utilizing primary storage for storing the storage system's data-set and a secondary storage for storing backup data, dirty data refers to any data written to a primary storage entity which is yet to be copied to a secondary backup storage entity. This type of data is referred to as “dirty data” not because of its correctness, but rather because of the temporary unconformity between information in the primary storage and in the secondary storage. Dirty data exists in particular when the backup strategy implemented by the system is asynchronous with the storage of the data within the primary storage.

Throughout the description of the present invention reference is made to the term “backed-up data blocks” and the like. Unless specifically stated otherwise, the term “backed-up data blocks” relates to any data-blocks that are part of the storage system's data set for which there is corresponding backup-data in the system. In a multi-layered storage system, the “backed-up” data may reside within the primary storage layer of the system and the backup data may be stored in a secondary storage layer. The backup data may be used to restore the “backed-up data” in the primary storage layer in case it is lost or corrupted. When for a certain data item within the primary storage layer there isn't an up-to-date counterpart in the backup storage, this data (in the primary storage layer) is regarded herein as being “dirty data”.

Throughout the description of the present invention reference is made to the term “data chunk”, “data segment” and in short—“chunk” and “segment”, respectively. The terms “data chunk”, “data segment”, “chunk” or “segment” are known in the art and the following definition is provided for convenience purposes. The terms “data chunk”, “data segment” and in short—“chunk” and “segment” describe a sequence of several blocks. Non-limiting examples of a data chunk or segment include: one or more blocks or tracks received by the system from a host, such as a stream of SCSI blocks, a stream of Fiber Channel (FC) blocks, a stream of TCP/IP packets or blocks over TCP/IP, a stream of Advanced Technology Attachment (ATA) blocks and a stream of Serial Advanced Technology Attachment (SATA) blocks. Yet further by way of example, a data chunk or segment may relate to a group of blocks stored in sequence within a storage medium, In this regard, a chunk or a segment relates to a sequence of successive physical storage locations within a physical storage medium.

Throughout the description of the present invention reference is made to the term “I/O command” or “ I/O request”. These terms are used interchangeably. The terms “I/O command” and “I/O request” are known in the art and the following definition is provided for convenience purposes. Accordingly, unless stated otherwise, the definition below shall not be binding and this term should be construed in accordance with their usual and acceptable meaning in the art.

An “I/O command” or an “I/O request”, as generally referred to herein, is an instruction to a storage system with reference to a certain data element that is part of the current data-set of the storage system or that is to become a part of the current data-set of the storage system. Typical types of I/O command/request include a read command/request that is intended to instruct the storage system to retrieve a certain data element(s) that is stored within the storage system, and a write command/request that is intended to instruct the storage system to store a new data element(s) within the storage system or to update a previous version of a data element which already exists within the storage system.

It would be appreciated, that many storage interface protocols include different variants on the I/O commands/requests, but often such variants are essentially some form of the basic read and write commands/requests.

By a way of example, the SCSI protocol supports read and write commands on different block sizes, but it also has variants such as the verify command which is defined to read data and then compare the data to an expected value.

Further by way of example, the SCSI protocol supports a write-and-verify command which is effective for causing a respective storage system to store the data to which the command relates and to read the data stored and verify that the correct value was stored within the storage system.

It would be appreciated that certain I/O commands may relate to non-specific data elements while other I/O commands may relate to the entire data set of the storage system as a whole. Such commands may be regarded as a batch command relating to a plurality of data elements and may initiate a respective batch process.

Throughout the description of the present invention reference is made to the term “recovery-enabling data”. Unless specifically stated otherwise, the term “recovery-enabling data” and the like shall be used to describe certain supplemental data (R) that is stored within the system possibly in combination with one or more references to data elements which are part of the current data-set of the storage system and which (collectively) enable(s) recovery of a certain (other) data element (D) that is part of the data-set of the storage system. Each recovery-enabling data-element (R) may be associated with at least one original data element (D) which is part of the current data-set of the storage system. Each recovery-enabling data-element (R) may be usable for enabling recovery of the original data element (D) with which it is associated, for example, when the original data (D) is lost or corrupted. A recovery-enabling data-element (R) may enable recovery of the corresponding data element (D) based on the data provided by recovery-enabling data (R) (e.g., the supplemental data with or without references to other data elements) and the unique identity of the respective data element which is to be recovered. Non-limiting examples of recovery-enabling data may include: a mirror of the data element (the supplemental data associated with a data elements is an exact copy of the data element—no need for references to other data elements); parity bits (the supplemental data associated with a data element are the parity bits which correspond to the data element and possibly to one or more other data elements and with or without references to the data element and to the other data elements associated with the parity bits); error-correcting code (ECC). It would be appreciated that while in order to recover a certain data element, in addition to certain supplemental data (e.g., parity bits), references to the other data elements may be required, the references to the other data elements may be obtained by implementing an appropriate mapping function (or table) and thus, the recovery-enabling data may not be required to include the reference to the other data elements associated with the supplemental data. However, in other cases, each recovery-enabling data element (e.g. parity bits) may include explicit references to each data element that is associated with the respective recovery-enabling data element.

Throughout the description of the present invention reference is made to the term “physical storage location” or “physical storage locations” in the plural. The term “physical storage location” is known in the art and the following definition is provided for convenience purposes. Accordingly, unless stated otherwise, the definition below shall not be binding and this term should be construed in accordance with their usual and acceptable meaning in the art. “Physical storage location” is the representation that is used within a storage system to designate discrete or atomic hardware resources or locations where data can be stored. For example, on a Dynamic Random Access Memory (DRAM) unit, a physical storage location may be each cell of the unit, which is typically capable of storing 1 bit of data. A technology known as “multi-level cell” or “MLC” in abbreviation enables storage of multiple bits in each cell. In a further example, each physical storage location may be associated with a chunk of multiple hardware cells which are monolithically allocated for storing data within the storage device and cannot be individually allocated for storage. Further by way of example, a physical storage location may be defined by to a specific hardware addressing scheme or protocol used by a computer storage system to address I/O requests referencing logical storage addresses to explicit hardware physical storage locations, and each physical storage location may correspond to one more cells of the storage unit and to one or more bits or bytes. Further by way of example, a physical storage address may be a SCSI based physical storage address.

Throughout the description of the present invention reference is made to the term “logical storage address”. The term “logical storage address” or the interchangeable term “virtual storage address” is known in the art and the following definition is provided for convenience purposes. Accordingly, unless stated otherwise, the definition below shall not be binding and this term should be construed in accordance with their usual and acceptable meaning in the art. A logical storage address is an abstraction of one or more physical storage locations. As an example, in a block-based storage environment, a single block of information is addressed using a logical unit number (LUN) and an offset within that LUN—known as a Logical Block Address (LBA).

Throughout the description of the present invention reference is made to the term “release” or the like with reference to storage resources. The term “released” as used with reference to storage resource is known in the art and the following definition is provided for convenience purposes. Accordingly, unless stated otherwise, the definition below shall not be binding and this term should be construed in accordance with their usual and acceptable meaning in the art. The term “release” describes the process of designating that data stored in a certain location(s) (or addresses) in a storage unit may be discarded or written over, and the discard or overwrite operation will not affect the integrity of the data set of the storage unit, for example as presumed by the external host (or hosts) interacting with the data set.

Throughout the description of the present invention reference is made to the terms “destage”, “destaging” or the like with reference to data within a storage device or module. Interchangeably with the term “destaging”, the term “flush” or “flushing” is also used. The terms “destage”, “destaging”, “flush” or “flushing” as used herein are known in the art and the following definition is provided for convenience purposes. The terms “destage”, “destaging”, “flush” or “flushing” relate to the process of copying data from a first data-retention unit to a second data-retention unit, which is typically functionally or otherwise different from the first data-retention unit. In a similar manner the terms “destage”, “destaging”, “flush” or “flushing” relate to the to the process of copying data from a first data-retention layer or tier to a second data-retention layer or tier. In one non-limiting example, a destaging process may be used for the purpose of releasing the storage resources allocated by the first data retention unit for storing the destaged data.

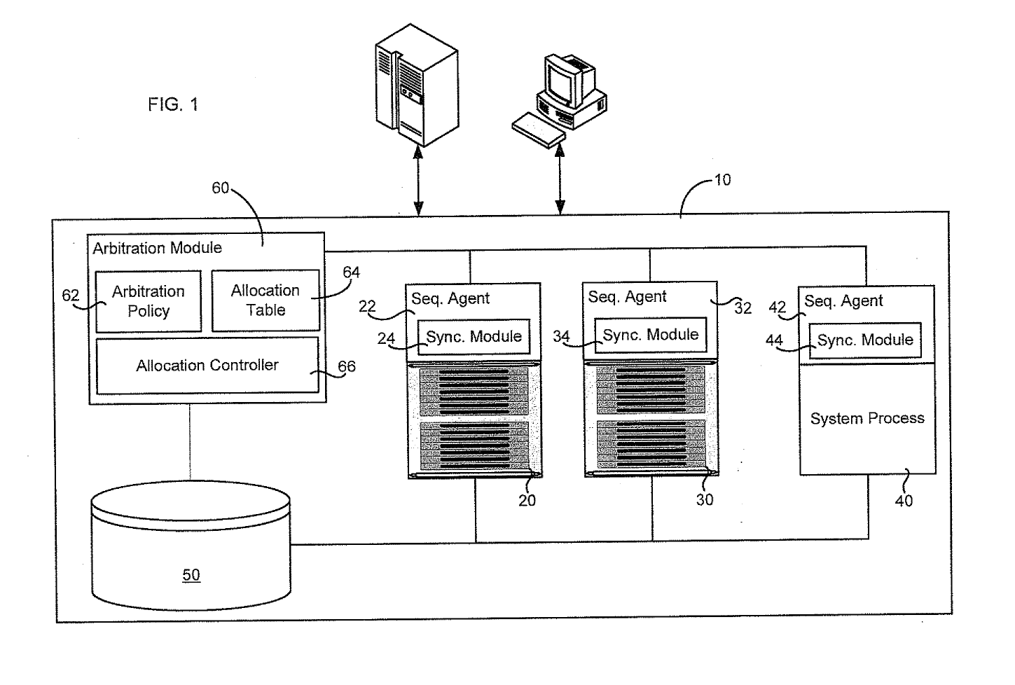

Reference is now made to FIG. 1, which is a block diagram illustration of a mass storage system including a system for managing access to a shared storage entity, according to some embodiments of the present invention. In FIG. 1, there is shown a multi-tier storage system 10, sometimes also referred to as a hierarchical storage system. The hierarchical storage system 10 of FIG. 1 is a non-limiting example of a storage system wherein the system for managing access to a shared storage entity may be implemented. As part of some embodiments of the invention, the mass storage system 10 may include two primary storage entities 20 and 30, a system process 40 and a shared storage entity 50 that is used by each of the two primary storage entities 20 and 30 and the system process 40 for storing data. For example primary storage entities 20 and 30 may use the shared storage entity 50 as secondary storage—for storing backup data, and the system process 40 may use the shared storage entity 50 as its main storage facility and may store auxiliary data thereon, such as system performance statistics. The two primary storage entities 20 and 30 and the system process 40 are provided here as examples of entities which share the I/O resources of the shared storage entity 50. It would be appreciated that the number of storage entities including primary storage entities and/or the number of system processes or any other type of entities associated with the shared storage entitiy may be any other number.

As mentioned above, by way of example, the storage system 10 is a hierarchical storage system. The storage system may include a primary storage layer that is used for storing the data-set of the storage system 10. Each of the primary storage entities 20 and 30 may be part of (or may constitute) the primary storage layer, and may be used for storing at least of portion of the entire data-set of the storage system 10. For example, the primary storage entities 20 and 30 may allocate certain physical storage locations which are mapped to certain logical storage addresses. The logical storage addresses mapped to the physical storage locations allocated by the primary storage entities 20 and 30 constitute a certain segment of the address space provisioned by the storage system 10. Thus, for example, when a host 50 issues a write request referencing a logical storage address that is mapped to a physical storage location on storage entity 20, the write request is serviced by writing data to the physical storage location within storage entity 20 that is associated with the logical storage address referenced by the write request. Similarly, read requests referencing a logical storage address that is mapped to physical storage locations on storage entity 20 are serviced by accessing the respective physical storage locations within storage entity 20. In this regarded, each of the primary storage entities 20 and 30 is described herein as being used for storing a data-set of the storage system 10 (being a part of the entire data set of the storage system).

At least a portion of the physical storage resources of the shared storage entity 50 may be allocated to a secondary storage layer of the storage system 10. The secondary storage layer is used for backing up the primary storage layer. In some embodiments, a second portion of the physical storage resources of the shared storage entity 50 are allocated for storing auxiliary system data, which is generated by the storage system as part of its operation, an in the case of the system shown in FIG. 1, by the auxiliary data is generated by system process 40, and is transparent from a user's perspective. The system process 40 uses the shared storage entity 50 as its main storage facility. Accordingly, the storage resources provided by the shared storage entity 50 entity are shared amongst the two primary storage entities 20 and 30 and the system process 40. Access to the shared storage entity 50 entity is also shared amongst the two primary storage entities 20 and 30 and the system process 40. For convenience throughout the specification and the claims each entity which generates I/O requests and streams of I/O requests that are intended for the shared storage entity is generally referred to as an “initiator” or “initiators” for a plurality (two or more) of such entities.

Continuing with the description of the storage system 10 illustrated in FIG. 1, as part of some embodiments, each of the initiators 20, 30 and 40 may accumulate I/O requests which are intended for the shared storage entity 50. For example, each of the initiators 20, 30 and 40 may include or be associated with an I/O buffer. In some implementations, one or more of the initiators 20, 30 and 40 may use a dedicated buffer for write requests and a dedicated buffer for read requests. In other implementation the buffer may be omitted and instead a registry is used to record which data needs to be read and/or written to the shared storage entity 50 (and in general). For example, in the case where the primary storage entities 20 and 30 are based on VS devices and the shared storage entity 50 is used for backing up new or updated data that was recently stored within the primary storage entities 20 and 30, retrieving the required data is a fast process, so it may be sufficient to record pointers to new or updated data rather than to use a dedicated (write) buffer, VS devices were described in co-pending PCT Patent Application PCT application No. IL2009/001005 filed Oct. 27, 2009 assigned to a common assignee.

The present subject matter relates to a method and a system for managing access to a shared storage entity. The storage system shown in FIG. 1 and described herein shall be used as an example of a storage system where the access management system of the present invention may be implemented. According to some embodiments, the access management system according to the present invention may include local sequencing agents and an arbitration module. In FIG. 1, local sequencing agents 22, 32 and 42 are operatively coupled to each of the initiators 20, 30 and 40. According to current subject matter, each local sequencing agent 22, 32 and 42 is adapted to locally sequence its respective initiator's I/O requests, thereby forming locally sequenced 110 streams. Each local sequencing agent 22, 32 and 42 can be adapted to sequence the respective initiators' 20, 30 and 40 I/O requests independently of the I/O requests of any of the other initiators.

The arbitration module 60 is also operatively connected to each of the initiators 20, 30 and 40. The arbitration module 60 is adapted to manage an access cycle to the shared storage entity 50. Each distinct access cycle (iteration) provides a certain timeframe (also referred to herein as “access cycle timeframe”) during which an access cycle allocation scheme is implemented. During a given access cycle timeframe, the access cycle timeframe allocation scheme allocates to each one of the initiators associated with a shared storage entity a continuous subframe (a portion of the timeframe) during which the respective initiator is granted exclusive access to the shared storage entity 50. During each such subframe, the respective initiator is provided with a substantially uninterrupted access to the shared storage entity 50.

According to the present subject matter, each of the initiators 20, 30 and 40, implements its own, locally ordered, I/O stream. In one example, the term “locally ordered” includes also the case where the entity does not change the order of the I/Os it receives and processes the I/Os in the same order by which they are received by the entity. Each initiator 20, 30 and 40 may seek to optimize its own access to the shared storage entity 50, according to its own requirements, priorities, limitations, capabilities and according to the makeup of its pending I/Os to the shared storage entity 50. According to some embodiments, each one of the initiators 20, 30 and 40 may be insensitive to the requirements, priorities, limitations, capabilities and pending I/Os makeup of any of the other initiators associated with the same shared storage entity 50.

In some embodiments, the arbitration module 60 is adapted to implement predefined subframe allocation criteria to determine the allocation of an access cycle timeframe among the plurality of initiators 20, 30 and 40. A dedicated arbitration policy module 62 where the criteria is set and stored may be provided. The subframe allocation criteria may set forth an allocation scheme and may be used to determine the portion of an access cycle timeframe that should be allocated to each of the plurality of initiators 20, 30 and 40. The allocation scheme is used to determine the size of the subframe that is to be allocated to each of the initiators 20, 30 and 40. Based on the allocation scheme, the time-slice that is awarded to each of the initiators is deteimined, for allowing each of the initiators to exclusively access the shared storage entity 50 during its allocated time-slice and to destage its own, locally sequenced I/O stream. The access cycle timeframe allocation scheme may be recorded in an allocation table 64. The allocation scheme may include a buffer in between the subframes allocated to the initiators. It would be appreciate that buffers may be required in order to allow the read/write mechanism to move to the location within the shared storage entity 50 that is associated with the storage space of the initiator to which the next subframe was assigned.

The flow of an access cycle timeframe, including the initiation of the access cycle timeframe and the transition from one initiator to another, may be controlled by an allocation controller 66. According to some embodiments, each of the initiators 20, 30 and 40 may receive instructions from the allocation controller 66 according to its respective subframe allocation. The allocation controller 66 may also program each of the initiators 20, 30 and 40 with the current access cycle timeframe configuration. The access cycle timeframe configuration and the subframe allocation may be provided to the initiators before each access cycle timeframe or only when changes occur. The allocation controller 66 may also set the order by which the initiators interact with the shared storage entity 50 during a timeframe.

In some embodiments, the arbitration module 60 is implemented as a master component and each of the initiators 20, 30 and 40 are slaves. The initiators 20, 30 and 40 are allowed to access the shared storage entity 50 only upon receiving and in accordance with instructions from the arbitration module 60. The arbitration module 60 is adapted to thus enforce the access cycle timeframe configuration and the allocation of the access cycle subframes to the different initiators 20, 30 and 40.

In some embodiments, each of the initiators 20, 30 and 40 may include a synchronization module 24, 34 and 44, respectively, and the initiators may be synchronized with on another and/or with the arbitration module 60. Once the timeframe and subframe allocation scheme are determined and distributed to the involved initiators 20, 30 and 40, the initiators themselves 20, 30 and 40 may be responsible for adhering to the prescribed access allocation timeframe scheme and for the handoff from one initiator to the next.

The subframe allocation criteria may be related to the functional characteristics of each of the initiators 20, 30 and 40. According to the present subject matter, the subframe allocation criteria are independent of any characteristics of any specific I/O request or I/O stream. Thus, for example, say that under certain circumstances a specific write request originating from the primary storage entity 30 should be serviced with low-latency. The low-latency requirement associated with this specific (or any other) I/O request would be transparent to the arbitration module 60. The arbitration module 60 may, however, implement allocation criteria which prescribes a large chunk (subframe) of an access cycle (timeframe) to the primary storage entity 30, and thus would allow the primary storage entity 30 to keep its buffer relatively free, and consequently allow generally low latency writes to the shared storage entity 50. Furthermore, the local sequencing agent 32 may (or may not) promote the low-latency write request internally within the primary storage entity's 30 internal queue, and subsequently also promote the writing of the low-latency write request to the shared storage entity 50, However, in some cases, the local sequencing agent 32 may decide, based on local criteria that despite being a low-latency write request, other pending I/O requests within the primary storage entity 30 should be serviced by the primary before this request and the local sequencing agent 32 may decide not to include this specific low-latency write request in the I/O stream intended for the current (or the subsequent) access cycle timeframe, In another example, at a certain point, the primary storage entity 30 may not have any pending low-latency I/O requests, but would still receive the large chunk of an access cycle timeframe, since this information is transparent to the arbitration module 60, and according to the allocation criteria that it implements, a large chunk of an access cycle timeframe should be allocated to the primary storage entity 30. In an alterative implementation provided here by way of example, in case an initiator reaches or is approaching the end of its pending I/Os list before the end of the subframe which was allocated to that initiator, at least a portion of the unused subframe duration may be reallocated to one or more of the other initiators that interact with the shared storage entity.

According to some embodiments, the access sequencing procedure of the local sequencing agents' 22, 32 and 42 controls an I/O scheduling procedure provided by an operating system associated with the shared storage entity 50 by controlling the number of I/Os forwarded in parallel to the operating system, and by selecting the locations of the. I/Os forwarded in parallel to operating system. For example, the arbitration module 60 possibly in cooperation with the local sequencing agents' 22, 32 and 42 may control the passing of I/Os to the operating system, such that all but one of the pending I/O streams is forwarded during a given time period, and so during that time period, the operating system is aware of only that particular I/O stream and is not aware of any other pending I/O streams, and the I/O scheduling procedure provided by an operating system is thus controlled.

In further embodiments, the access cycle allocation determined and provided by the arbitration module 60 may control an I/O scheduling procedure provided by an operating system associated with the shared storage entity 50. By way of example, the arbitration module 60 may include data or may be configured with data in respect of the requirements and other characteristics of each of the functional entities within the storage system that share access to the shared storage entity 50 (at any given state). For example, the arbitration module may have a-priori data with regard to the applications which are associated with each of the entities, and with regard to expected average (or other statistical measures) importance of the I/O streams coming from some or all of the entities. Further by way of example, the arbitration module 60 may use parameters relating to estimated or average (or other statistical measures) requirements, such as throughput and latency, of typical, random or hypothetical I/O streams arriving from a given functional entity to generate an importance measure for that functional entity. For example, the arbitration module 60 can thus determine an allocation of subframes (being part of a timeframe) for each initiator 20, 30 and 40 based on the typical, average, etc. importance of the typical (or average, etc.) I/O streams coming from each of the initiators. Further by way of example, the arbitration module 60 can generate a general access allocation scheme with respect to the shared storage entity 50 which matches the arbitration module's 60 information with regard to the typical, average, etc. importance of the typical (or average, etc.) I/O streams coming from each of the initiators,

The subframe allocation criteria and the access allocation scheme generated by the arbitration module 60 based thereon may be influenced by one or more of the following:

a. An importance profile or an importance indication associated with one or more of the initiators.

b. The amount of pending I/Os intended for the shared storage entity by one or more of the initiators. The amount of I/Os can be measured in various ways, including the size of the data to be stored on the shared storage entity, the number of I/Os' etc. Various statistical measures may be used to compute the figure which represents the amount of pending I/Os and/or the expected amount of pending I/Os, including statistical measure which involves moving and/or weighted averages.

c. The I/O profile of one or more of the initiators. An I/O profile is a statistical measure which characterizes the type of I/O commands that are typically issued by the initiator to the shared storage entity 50. The I/O profile may relate to the following parameters: the typical sequentiality of the I/Os from the initiator, for example, are the I/Os from the initiator generally characterized as being sequential, semi-sequential (e.g., various levels of sequentially may be used to indicate a sequentially level), random?; the origin of the I/Os from the initiator. For example, are the I/Os from the initiator are locally originated, or are the I/Os from the initiator originate from an external entity?; and the expectation of future I/O commands from the initiator (for example, are future I/O commands expected soon or not? will future I/O commands from the initiator be in sequence with current I/Os or not); the I/O timeout imposed on or by one or more of the initiators.

It would be appreciated that one of more of the above factors may change from time to time. In some embodiments, the arbitration module 60 may be responsive to a change in one or more of the above factors for recalculating the access cycle timeframe allocation. In other embodiments, the access cycle timeframe allocation scheme is routinely computed once every certain period of time, and it is not responsive to a particular event. In still further embodiments, a hybrid approach is implemented according to which, in response to some factor changes the access timeframe allocation scheme is computed and in other cases the recalculation is not carried out when one or more factors change, but rather at a predefined time or interval. For example, the access timeframe allocation scheme may be revised after a certain predefined number of access cycles (timeframes). I another example, the access cycle allocation scheme may be revised when the importance of one of the initiators is modified. In yet a further example, the timeframe allocation scheme may be modified when the extent of pending I/Os to the shared storage entity 50 at one of the initiators grows beyond a certain threshold. Still further by way of example, the timeframe allocation scheme may be modified when a certain number of timeouts (including one) occur at one of the initiators or in connection with pending I/Os at one of the initiators.

The duration of an access cycle timeframe may also be adapted. The duration of a timeframe and the adaptation thereof shall also be described below.

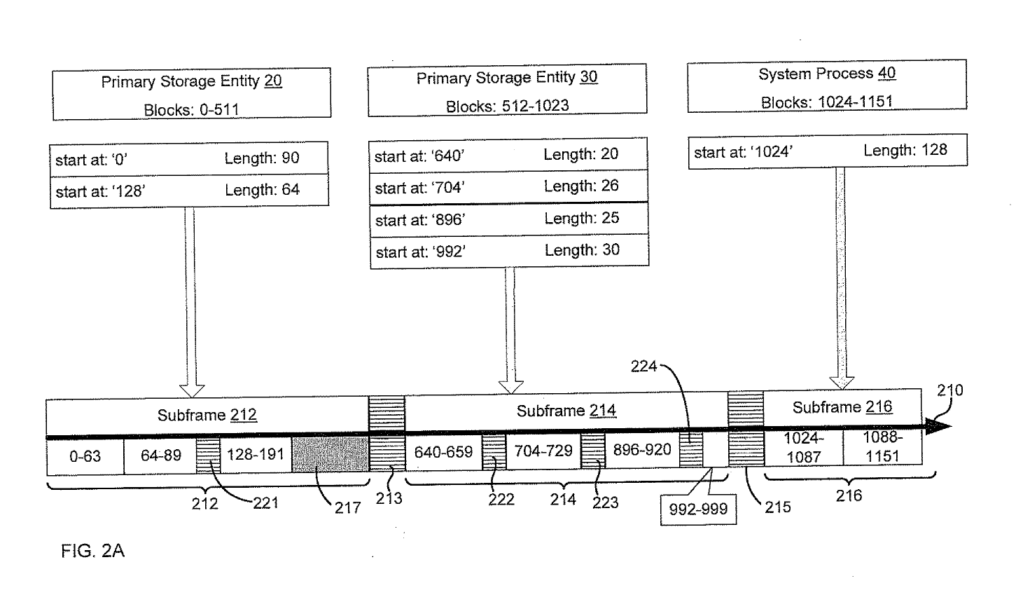

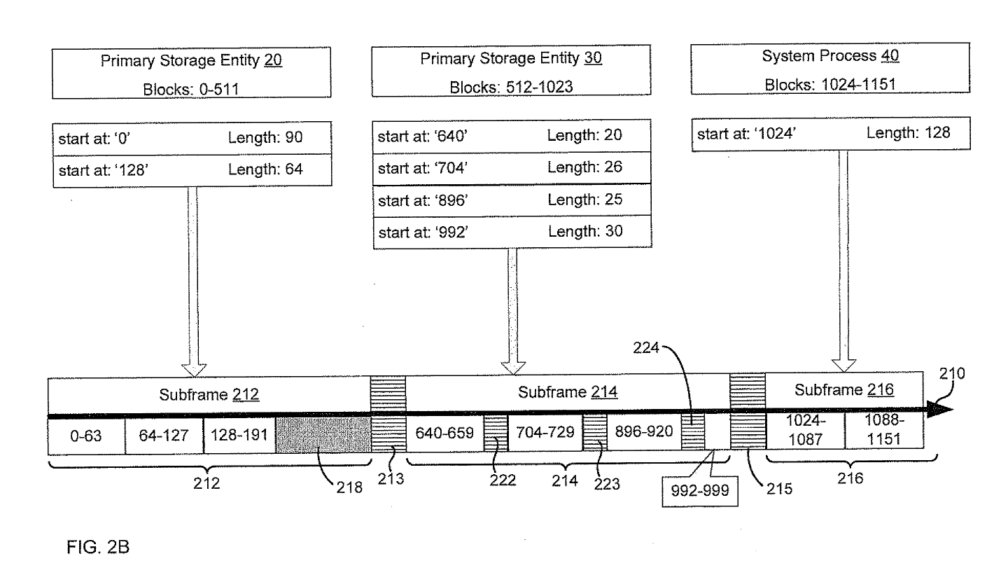

Reference is now made to FIG. 2A, which is a graphical illustration of an access cycle timeframe management procedure implemented with respect to the shared storage resource of the storage system shown in FIG. 1, according to some embodiments of the present invention. By way of non-limiting example, in FIG. 2A, primary storage entity 20 is associated with logical storage addresses 0-511, primary storage entity 30 is associated with logical storage addresses 512-1023, and system process 40 is associated with logical storage addresses 1024-1151. It would be appreciated that other mapping schemes may be implemented for mapping physical storage resource of each of the initiators 20, 30 and 40 to corresponding physical storage resources of the shared storage entity 50. For convenience, in FIG. 2A all I/Os issued by the initiators 20, 30 and 40 to the shared entity 50 are write commands. However, it would be apparent to those of versed in the art that the description provided below can be readily applied to read commands and to a combination of reads and writes, and I/O commands such as “verify” “write-verify”, “read-verify” for storage entities which support such commands. An example of access cycle management which takes into account reads and write to the shared storage entity shall be provided below.

Arrow 210 represents the duration of one complete access cycle timeframe to the shared storage entity 50. By way of example, the arbitration module 60 may set an access cycle timeframe duration. In some embodiments, the arbitration module 60 may set an access cycle timeframe duration at least based on the I/O time-out duration that is implemented within the storage system 10. For example, the arbitration module 60 may set an access cycle timeframe duration to be lower than the I/O time-out duration that is implemented within the storage system 10. This configuration may provide each of the initiators 20, 30 and 40 with an opportunity to write its data to the shared storage entity 50 before the I/Os expire and will need to be reissued. The access cycle timeframes may be successive, with each timeframe being substantially immediately followed by the next. In some embodiments, a small buffer may be implemented between each two timeframes. In further embodiments, the buffer may be intended for allowing the write mechanism to be reset for the next access cycle (timeframe).

The arbitration module 60 may allocate an access cycle timeframe and divide it among the initiators 20, 30 and 40 or among a subset of the initiators associated with the shared storage entity 50. The allocation of an access cycle timeframe can be determined in accordance with predefined timeframe allocation criteria. Various access cycle timeframe allocation criteria may be used. In FIG. 2A there is depicted one timeframe allocation approach, whereby each of the initiators 20, 30 and 40 is allocated with a continuous subframe which spans a predefined portion of a complete access cycle timeframe. By way of non-limiting example, each of the primary storage entities may be allocated with a subframe 212 and 214, respectively, which constitutes 36% of the complete timeframe 210, and the system process 40 may be allocated with a subframe 216 that constitutes 18% of the complete timeframe 210. The remaining 10% may be equally divided and used as buffers 213 and 215 in between consecutive subframes to allow the read/write head to be positioned to the area within the shared storage entity 50 that is associated with the initiator for which the next subframe was allocated.

Possibly, over a series of access cycle timeframes, the arbitration module 60 can be configured to allocate at least one of the access cycle timeframes among a subset of the initiators 20, 30 and 40. In other words, across different access cycle timeframes, the arbitration module 60 may be configured to change the makeup of the group of initiators which receive a subframe allocation during a particular timeframe (or during a group of timeframes), and can thus alter the composition of initiators that access a particular shared storage entity during different access cycle timeframes. In one example, the system process 40 may only generate I/Os every other access-cycle, and so the arbitration module 60 can be configured to include the system process 40 in the access cycle timeframe allocation scheme only every other access cycle timeframe. In an alternative implementation, the arbitration module 60 may be configured to discover this behavior of the system process 40, and in response, it may adapt the timeframe allocation criteria, so that the system process 40 is omitted from every other access cycle timeframe allocation scheme.

Each of the initiators 20, 30 and 40 is responsible for organizing the I/O stream that it issues to the shared storage entity 50. The arbitration module is not involved in the organization of the I/O streams of the various initiators 20, 30 and 40. In some embodiments, the arbitration module 60 is completely insensitive to the characteristics the various I/O commands that are pending to be addressed to the shared storage entity 50.

As part of some embodiments, each of the initiators 20, 30 and 40 may hold a queue or any other type of list where its pending I/O commands intended for the shared storage entity 50 are recorded and prioritized. Within each access cycle timeframe, during its respective allocated subframe, each one of the sequencing agents 22, 32 and 42 may issue its pending I/O commands intended for the shared storage entity 50 from the list or queue according to the internally determined priority of the I/O commands. In this respect, each one of the sequencing agents 22, 32 and 42 may decide which I/O command to issue during the current access cycle timeframe, and by what order. The sequencing agents 22, 32 and 42 may decide to delay certain I/O commands to subsequent access cycle timeframes.

By way of example, the sequencing agent of each of the initiators 20, 30 and 40 may be configured to take into account one or more of the following factors for determining its own I/O stream to the shared storage entity 50 during a given access cycle timeframe:
The identity and/or characteristics of the source entity (interacting with the initiator) which caused the initiator entity to generate the I/O command intended for the shared storage entity. For example, if a host that is known to be a source of critically significant data has stored data on one of the primary storage entities, the sequencing agent of that primary storage entity may assign high priority to the I/O command intended for destaging a backup copy of the critically significant data to the shared storage entity in order to promote be able to complete the storage sequence for this data.
The importance of the I/O command intended for the shared storage entity. In the above example, the importance of the I/O command intended for the shared storage entity was derived from the identity of the host which caused the initiator entity to generate the I/O command intended for the shared storage entity. In other cases the importance of the I/O command intended for the shared storage entity may be otherwise determined, for example, through an explicit indication embedded within (e.g., using metadata) or otherwise associated with the data that caused the I/O command intended for the shared storage entity to be generated.
A latency requirement associated with the I/O command intended for the shared storage entity. The latency requirement may be explicit or implicit.
The sequentially of the data on the shared storage entity 50. In this respect, preference may be given to data that forms a large sequence within the shared storage entity 50. As can be seen in FIG. 2A, fragmented I/Os can introduce a seek time-period 221-224 in between two consecutive I/Os which involve non-sequential physical locations within the shared storage entity 50. Seek time-periods reduce the I/O throughput. An initiator may be configured to arrange its I/O stream vis-à-vis the shared storage entity 50 such that it is comprised of generally more sequential chunks within the shared storage entity 50 and is less fragmented. The advantage of this approach is illustrated in FIG. 2A, wherein although the two, similar primary storage entities 20 and 30 destage data under similar conditions to the shared storage entity 50, the size of the data stream that is destaged by primary storage entity 20 during its allocated subframe, is significantly larger than the data stream that primary storage entity 30 is able to destage during the same subframe duration. This difference is intended to show the advantage of I/O streams which are arranged so that they form a successive sequence within the shared storage entity 50.

Furthermore, although primary storage entity 20 is able to completely destage all the data that it needs to destage to the shared storage entity 50 before the end of its allocated subframe 212, and as a result an idle time duration 217 occurs at the end of the subframe 212. During the idle time duration 217 the shared storage entity 50 is idle, since this time is exclusively allocated to primary storage entity 20 which does not have any pending I/Os which are waiting to be services by the shared storage entity 50. As mentioned above, and discussed below other implementations are also contemplated in the present subject matter.

It would be appreciated that the proportions among the various depicted time durations, including the seek time-period 221-224 and the buffer periods 213 and 215, are purely exemplary and actual proportions may vary significantly.

According to the present subject matter, an initiator can be configured to join several (two or more) I/Os (for example, two or more destage chunks) and possibly also protected data (which is already backed up within the shared storage entity 50) together into a combined I/O stream which forms a successive sequence of data within the shared storage entity. An example of a flushing management method which may be used to form such an extended flush sequences is disclosed in U.S. Provisional Application No. 61/318,477, filed Mar. 29, 2010 which is incorporated herein by reference in its entirety.

Briefly, in U.S. Provisional Application No. 61/318,477 there is disclosed a storage system, comprising: a primary storage entity, a secondary storage entity and a flushing management module. With correlation to terminology used in the current description, the primary storage entity corresponds to an initiator, the secondary storage entity corresponds to a shared storage entity and the flushing management module corresponds to the sequencing agent of the initiator. In the disclosure of U.S. Provisional Application No. 61/318,477 the primary storage entity is described as being utilized for storing a data-set of the storage system, the secondary storage entity is described as being utilized for backing-up the data within the primary storage entity, and flushing management module is adapted to identify within the primary storage entity two groups of dirty data blocks, each group is comprised of dirty data blocks which are arranged within the secondary storage entity in a successive sequence, and to further identify within the primary storage entity a further group of backed-up data blocks which are arranged within the secondary storage entity in a successive sequence intermediately in-between the two identified groups of dirty data blocks. The flushing management module is adapted to combine the group of backed-up data blocks together with the two identified groups of dirty data blocks to form a successive extended flush sequence and to destage it to the secondary storage entity. It would be appreciated that in the context of the current subject matter an initiator is not necessarily a primary storage entity and the shared storage entity is not necessarily limited to function as a back-up storage for a primary storage layer. Similarly, the I/Os that are comprised of successive blocks may not necessarily be limited to I/Os that contain dirty data that needs to be backed up on the shared storage entity, and the intermediate successive data blocks may not necessarily be limited to backed up data blocks.

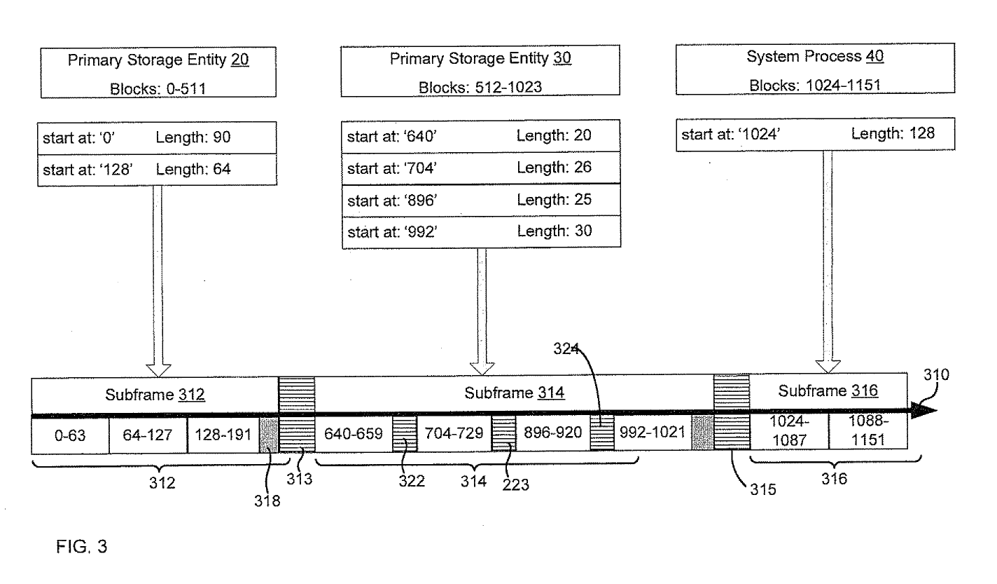

In order to illustrate the implementation of the method forming an extended flush sequences as part of the current subject matter, reference is now made to FIG. 2B, which is a graphical illustration of the implementation by a primary storage entity of the method of forming an extended flush sequences during the access cycle of FIG. 2A, according to some embodiments of the present invention. In FIG. 2B, the primary storage entity 20 forms an extended flush sequences by adding to its I/O stream intermediate blocks 90-127. Intermediate blocks 90-127 from a single successive sequence together with blocks 0-63, 64-89 and 128-191 from the original I/O stream. By way of example, blocks 0-63, 64-89 and 128-191 may be dirty data blocks which correspond to new or updated data that is not backed up within the shared storage entity 50, whereas blocks 90-127 are backed up data blocks. According to the current subject matter, the performance characteristics of the shared storage entity 50 may substantially favor successive I/Os and therefore, while more data is actually written to the shared entity 50 as a result of the padding operation, the overall amount of time required to complete the servicing of the larger, sequential I/O is typically (or statistically) less than the overall time required to service the original fragmented I/O stream. In FIG. 2B, this is illustrated by the larger idle period 218 (compared to idle period 217) at the end of the time-slice allocated to the primary storage entity 20, however this time saving can be used to enable a higher throughput of the same initiator or of one of the other initiators, as will be discussed with reference to FIG. 3 below.

Still further by way of example, the initiator may be characterized or may be configured to provide substantially better random read and write speeds compared to the shared storage entity's random write speeds, in particular when the share storage entity is servicing substantially small write operations.

The sequencing agents 22, 32 and 42 can be configured to control the flow of I/O commands to the shared storage entity 50 such that approximately when the subframe that was allocated to the respective initiator ends (or approaching its end), the flow of I/Os from that initiator stops. Alternatively, the arbitration module 60 controls the initiators 20, 30 and 40 and is configured to instruct an initiator to stop interacting with the shared storage entity 50 when the initiator's allocated subframe has ended or is about to end, and concurrently or immediately thereafter or after a short buffer period (for example, buffer 213) the arbitration module 60 can instruct the initiator for which the next subframe was allocated to start interacting with the shared storage entity 50.

According to further embodiments, the sequencing agents 22, 32 and 42 can take into account the performance capabilities of the shared storage entity 50 and possibly also certain parameters related to the current load on the shared storage entity 50 (or other performance related indicators or parameters) for controlling the flow of I/O commands to the shared storage entity 50. For example, the sequencing agents 22, 32 and 42 can evaluate which of its pending I/O commands to the shared storage entity 50 can be serviced during its allocated access cycle subframe and may generate its I/O stream for the current subframe accordingly. If according to the sequencing agent's evaluation not all of the pending I/O commands to the shared storage entity 50 can be serviced within the allocated subframe, the sequencing agent may defer some of the pending I/Os to the next access cycle timeframe.

The sequencing agents 22, 32 and 42 may also be adapted to dynamically control the I/O stream vis-à-vis the shared storage entity 50 during the access cycle subframe allocated to the respective initiator according to the condition and performance of the shared storage entity 50 and/or other components of the storage system 10 that are involved in the servicing of the I/Os, for example, so as not to saturate the shared storage entity 50 or any other resource of the storage system 10 that is involved in the process. For example, the sequencing agents 22, 32 and 42 may determine on-the-fly which I/O command is to be issued next, or it may adjust an existing list or a queue of I/O commands, for example, according to the current load on the shared storage entity 50.

For example, the arbitration unit 60, possibly in cooperation with the sequencing agents 22, 32 and 42 and as a matter of routine may be configured to issue a (relatively) small number of I/Os simultaneously to the shared storage entity 50 (e.g., a disk). It would be appreciated that by issuing a (relatively) small number of I/Os simultaneously to the shared storage resource 50, a relatively high degree of the resource's 50 bandwidth can be utilized, with a small impact on latency. In this regard, it would be appreciated, that when writing to disk (provided here as an example of a shared storage resource) it may be desirable to utilize the disk bandwidth together while minimizing the latency of I/Os to the disk. When sending a large number of I/Os to the disk simultaneously (or within a short period of time) the disk read/write bandwidth can become saturated, since there are always requests in the disk queue or in the disk cache so the disk bandwidth is utilized. On the other hand, if there are too many simultaneous (or substantially simultaneous) I/Os to the disk, the queues on the disks become very long and the latency of I/Os to the disk can increases significantly. Still further, when sending only a single I/O (or a relatively small number of I/Os) to the disk at a time, the I/O latency cab be very low but the disk is not “busy” enough, so the disk's potential bandwidth is not well utilized. Accordingly, by way of example, the arbitration unit 60, possibly in cooperation with the sequencing agents 22, 32 and 42 may be configured to be sensitive to the disk's bandwidth utilization and possibly also be sensitive to the current, typical, average, etc. I/O latency status and may control the number and size of the I/Os issued to the disk at one or more points in time accordingly. In further examples, the arbitration unit 60 may be preconfigured in advance in accordance with various predefined I/O profiles and in accordance with predefined I/O latency profiles and disk bandwidth parameters.

By way of example, there can be a plurality of channels operatively connecting each of (or some of) the initiators 20, 30 and 40 with the storage entity 50. The use of the plurality of channels during an access cycle subframe can be controlled by the sequencing agents 22, 32 and 42. For example, the sequencing agents 22, 32 and 42 can determine the number of channels that are to be used for interacting with the shared storage entity 50 and may use multi-threading technology to send a plurality of I/O streams to the shared storage entity 50, simultaneously, over two or more channels. The decision with regard to the number of threads to be invoked and the number of channels to be used can be associated with the performance characteristics or current condition of the shared storage entity 50 and/or other components of the storage system 10 that are involved in the servicing of the I/Os.

In FIGS. 2A and 2B, the allocation of the access cycle timeframe is rigid, and is not influenced by events or circumstances occurring during the access cycle timeframe. Therefore, by way of example, while primary storage unit 20 was able to complete all of its pending I/Os before the end of its subframe 212, primary storage unit 30, for which the subsequent subframe 214 was allocated, does not commence its interaction with the shared storage entity 50 before the full subframe 212 and the buffer 213 in between time-slices 212 and 214 have passed. As a result, an idle period 217 or 218 occurs at the end of the time-slice 212 allocated to the primary storage unit 20.

The rigid timeframe allocation approach is typically simpler to implement and involves less overhead. However, in circumstances where the I/O load at one or more of the initiator is less stable, a dynamic timeframe allocation approach can provide a better utilization of the system resources and may reduce latency spikes and shared storage idle time. FIG. 3 depicts a dynamic access cycle timeframe allocation scheme, shown as an alternative of the rigid timeframe allocation scheme in FIG. 213, in accordance with some embodiments.

According to this example of a dynamic timeframe allocation scheme, in case an initiator 20 reaches or is approaching the end of its pending I/Os list before the end of the subframe 312 which was allocated to that initiator, at least a portion of the unused subframe duration may be reallocated to one or more of the other initiators that interact with the shared storage entity 50. As discussed above, in an alternative implementation, the arbitration module 60 may be responsible for dynamically reallocating any slack subframe duration that is detected by or reported to the arbitration module during an access cycle timeframe.

By way of example, each initiator may monitor its own pending I/Os list and based on predefined or measured system performance parameters may estimate the amount of time required to complete its interaction with the shared storage entity 50. In case according to the estimation the initiator estimates that it would complete the servicing of all of its pending I/Os to the shared storage entity significantly before the end of its allocated subframe, the initiator may assign at least some of the estimated slack duration to one or more of the other initiators associated with the shared storage entity. The slack duration may be allocated to a specific one of the other initiators associated with the shared storage entity, or it may be equally divided among the remaining initiators.

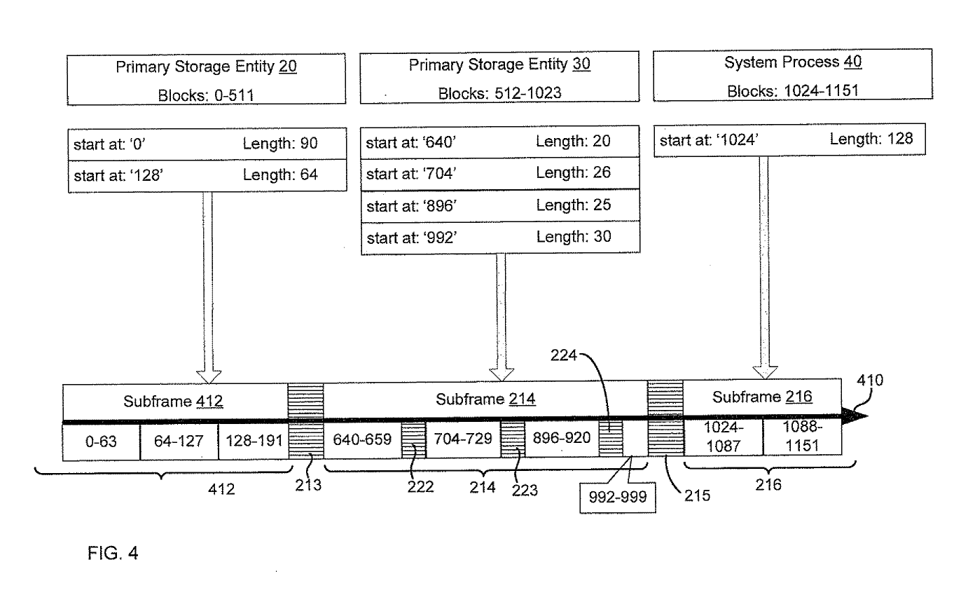

FIG. 4 depicts another alternative. In FIG. 4 the slack duration (idle periods 217 or 218 in FIGS. 2A and 2B respectively) at the end of the subframe 412 is not reallocated to any of the other initiators that are associated with the shared storage entity, and rather it is used to shorten the length of the subframe 412 that was allocated to the primary storage entity 20, and subsequently to shorten the entire access cycle timeframe 410. The other subframes 214 and 216 remain unchanged.

According to some embodiments, the access cycle timeframe allocation scheme may be sensitive to the state of the storage system 10. As an example of a storage system wherein at different states of the storage system certain functional entities change the profile of their I/O interaction with a shared storage entity, there is now provide a description of the system disclosed in co-pending PCT Patent Application PCT application No. IL2009/001005 filed Oct. 27, 2009 assigned to a common assignee.

The system proposed in PCT Patent Application No. IL 2009/001005 includes a primary storage space, a temporary backup storage space, a permanent backup storage space, a storage controller and one or more uninterrupted power supply (UPS) units. The primary storage space is associated with a plurality of volatile storage (“VS”) devices and is used for persistently storing the entire data-set of the storage system. The temporary backup storage space is also associated with a plurality of VS devices. The permanent backup storage space is associated with nonvolatile storage (“NVS”) devices. During a normal operation state of the storage system, the controller is responsive to a write request related to a data element being received at the storage system for implementing a provisional redundant storage sequence including: storing the data element within the primary storage space and substantially immediately or concurrently storing recovery-enabling-data corresponding to the data-element within the temporary backup storage space. The controller is configured to acknowledge the write request substantially immediately following completion of the storage within the primary storage space and within the temporary backup storage space, and the provisional redundant storage sequence is thus complete. The one or more UPS units are configured to provide backup power to extend data-retention on some or all of the VS devices in case of power interruption. Asynchronously with the provisional redundant storage sequence, the controller is configured to destage the recovery-enabling-data to the permanent backup storage space.

The controller of the proposed storage system may be configured to manage the asynchronous destaging of the recovery enabling data in accordance with a predefined permanent backup deferral policy which takes into account at least one parameter that is independent of the provisional redundant storage sequence of the respective data element. The deferral policy may provide a controlled timeframe for deferring the asynchronous destaging of the recovery enabling data relative to the storage system's response to the respective write request (the storage system response may be any one of the operations which are part of the provisional redundant storage sequence). The deferral policy may take into account the capacity of the UPS units and possibly other parameters.

During a normal operation state of the storage system (not power interruption) the UPS units are configured to provide backup power for at least the time-duration required for completing the destaging of data from the substantially temporary backup space (which is based on VS devices) to the substantially permanent backup storage layer (which is based on NVS devices), so that the entire data-set of the storage system is backed up on NVS devices before the storage system can gracefully shutdown.

Further as part of the proposed storage system, the controller may be responsive to an indication that the recovery-enabling-data was successfully destaged to the permanent backup storage space for releasing the temporary backup storage space resources that were used for storing the corresponding recovery-enabling-data. Once released, the storage resources of the temporary backup storage space can be used for storing other data, such as recovery-enabling-data corresponding to a data element that is associated with a more recent write command.

The storage capacity of the temporary backup storage space is substantially smaller than the storage capacity of the primary storage space. The storage capacity of the permanent backup storage space is substantially equal to (or larger than) the storage capacity of the primary storage space. At any time during the operation of the proposed storage system, the data stored within the primary storage space is protected by corresponding recovery-enabling-data that is stored within the temporary backup storage space or within the permanent backup storage space. During normal a operation state of the storage system, a relatively small portion of the data within the primary storage space is protected by data within the temporary backup storage space, and the permanent backup storage space protects at least the remaining data which is not protected by the data within the temporary backup storage space.

As is well known, the ability of a volatile data-retention unit to retain data is sensitive to main power interruption. It is therefore common to regard volatile data retention devices as “memory devices” and not as “storage devices”. However, it would be apparent to those versed in the art that within the storage system proposed in PCT Patent Application No. IL 2009/001005 assigned to a common assignee, the primary storage space which is associated with volatile data-retention devices (or “volatile storage devices”) in combination with other components and logic is configured for substantially persistently storing data. Specifically, the proposed storage system further includes: two complementary backup storage spaces: a temporary backup storage layer (or space) which is also associated with VS devices; and a permanent backup storage layer which is associated with NVS devices, a storage controller and one or more UPS units for providing backup power to enable full backup in case of power interruption and graceful shut-down, and a recovery controller for recovering the data into the primary storage space following data loss within the primary storage space.

The VS devices associated with the primary storage space are therefore regarded as storage devices, despite their inherent volatility, since the logical storage addresses that are used by the storage system for servicing I/O requests from external sources are associated with physical storage locations on VS devices, and this configuration is restored in case of power interruption before normal operation of the storage system is resumed. It would be appreciated that this sort of behavior is characteristic of storage devices.

During a normal operation state of the storage system, I/O requests from external sources (which typically reference logical storage addresses) are mapped to physical storage locations allocated for the primary storage space by the VS devices associated with the primary storage space. Thus, during a normal operation state, read requests are serviced by accessing the physical storage locations within the primary storage space that are mapped to the logical storage addresses reference by the I/O read request, and write requests involve In case of failure within the primary storage space. The servicing of I/O write requests during a normal operation state was described above in length and involves interaction with the primary storage space and with each of the temporary backup storage space and the permanence backup storage space.

When data within the primary storage space is compromised (e.g., lost or corrupted), for example, as a result of a power failure (or for any other reason), the storage system can switch to the data recovery state. In the recovery state, in addition to the reading of data from the primary storage space and the writing of data to each of the primary storage space, the temporary backup storage space and the permanence backup storage space, the data that was compromised is written from the PBS space to the primary storage space. In case of severe power interruption, a substantial portion (e.g., all) of the data within the primary storage space may be lost. The entire data set of the storage system is stored within the NVS devices underlying the permanent backup storage layer, and once normal power is restored, the system, now operating in the recovery state, may recover the lost into the primary storage space and normal I/O operations are resumed vis-à-vis the VS devices associated with the primary storage space.

From a user's (host) perspective, the data protection and the data availability capabilities of the proposed storage system are similar to the protection and availability provided by many commercially available non-volatile storage systems, such as hard-drive disk (“HOD”) based storage system (including various RAID implementations), or in another example, such as non-volatile solid-state disk (“SSD”) flash based storage systems. For example, when a read command is received at the proposed storage system, say from a host, the storage system controller reads the logical storage address referenced by the read command and determines the corresponding physical storage location(s) associated with the referenced logical storage address. The physical storage location(s) point towards specific locations within one or more of the first plurality of VS devices associated with the primary storage space. The storage system controller reads the data stored on the VS device(s) at the physical storage location(s) determined to be associated with the read command and communicates the data back to the host.

Returning now to the context of the present subject matter, two storage devices which underlie the primary storage space and/or the temporary backup storage space may correspond to the primary storage devices that share access to a shared storage entity. The shared storage entity may correspond to a storage device underlying the permanent backup storage space which is used for backing up data that resides on two or more different storage devices which underlie the primary storage space and/or the temporary backup storage space. The system process according to the present subject matter may be any other resource or process within the storage system which shares the I/O resources of the shared storage entity. In analogy to the storage system described in PCT Patent Application No. IL 2009/001005, so far the present subject matter described the operation of the storage system during a normal operation state.

There is now provided a brief description of the operation of the storage system according to the present subject matter when operated in analogy to the recovery system state described in PCT Patent Application No. IL 2009/001005. For simplicity, the function of the TBS space shall be ignored herein, and instead it is assumed that during a normal operation state of the storage system data is destaged to the shared storage entity directly from the primary storage entities associated with the shared storage entity. For illustration, an access cycle timeframe scheme which may be implemented by the arbitration module during a recovery state of the storage system is described now on the basis of the access cycle timeframe allocation scheme depicted and described with reference to FIG. 2A. The access cycle timeframe allocation scheme depicted and described with reference to FIG. 2A shall be used as an example of an access cycle timeframe allocation scheme that is implemented by the arbitration module during a normal operation state of the storage system.

As mentioned above, according to the access cycle timeframe allocation scheme depicted and described with reference to FIG. 2A, each of the primary storage entities is be allocated with a subframe which constitutes 36% of the complete timeframe and the system process may be allocated with a subframe that constitutes 18% of the complete timeframe. The remaining 10% may be equally divided and used as buffers and in between consecutive subframes to allow the read/write head to be positioned at the area within the shared storage entity that is associated with the next subframe was allocated.

By way of example, during the recovery state, the arbitration module may add two additional subframes, one of the two subframes for writing recovery data to a first among the two primary storage entities associated with the shared storage entity, and the other subframe for writing recovery data to the other primary storage entity associated with the shared storage entity. The arbitration module may be required to allocate during a timeframe two more buffers to enable the shared storage entity's read/write head repositioning as was explained above. A resulting access cycle timeframe allocation scheme may prescribe, for example, two subframes which constitutes 22.5% of the complete access cycle timeframe, one for writing recovery data from the shared storage entity to a first among the two primary storage entities associated with the shared storage entity, and the other 22.5% subframe for writing recovery data to the other primary storage entity associated with the shared storage entity; two subframes which constitutes 12.5% of the complete access cycle timeframe, one for writing new or updated data from a first among the two primary storage entities associated with the shared storage entity to the shared storage entity, and the other 12.5% subframe for writing new or updated data from the other primary storage entity associated with the shared storage entity to the shared storage entity; a subframe which constitutes 10% of the complete frame for the system process; and four buffer durations each spanning 5% of the complete frame in between each two consecutive timeframes allow the read/write head to be positioned at the area within the shared storage entity that is associated with the next subframe.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

While certain features of the invention have been illustrated and described herein, many modifications, substitutions, changes, and equivalents will occur to those skilled in the art. It is therefore to be understood that the appended claims are intended to cover all such modifications and changes as fall within the true scope of the invention.

1. A system for managing access to a shared storage entity, comprising:
two or more local sequencing agents, each associated with a respective one of two or more initiator entities which generate I/O requests for accessing the shared storage entity, and each local sequencing agent is adapted to locally sequence its respective initiator entity's I/O requests; and
an arbitration module adapted to manage an access cycle to the shared storage entity by allocating to each one of said plurality of initiator entities a monolithic/continuous chunk of the access cycle to implement its own I/O access sequence, wherein chunk allocation is determined according to subframe allocation criteria related to the functional characteristics of each of the initiator entities.

2. The system according to claim 1, wherein each local sequencing agent is adapted to sequence the respective initiator entity's I/O requests independently of the I/O requests of any of the other initiator entities.

3. The system according to claim 1, wherein the allocation criteria is independent of characteristics of any specific I/O request or I/O stream.

4. The storage system according to claim 1, wherein said local sequencing agents' access sequencing procedure overrides an I/O scheduling procedure provided by an operating system associated with the shared storage entity.

5. The storage system according to claim 2, wherein at least one of said functional entities is adapted to take into account a characteristic of the functional entity when determining the I/O scheduling during a frame allocated to the functional entity.

6. The storage system according to claim 5, wherein said characteristic of the functional entity include a measure of sequentiality of I/Os associated with the respective functional entity.

7. The storage system according to claim 5, wherein said characteristic of the functional entity include a type of application or applications which are associated with the respective entity.

8. The storage system according to claim 5, wherein said characteristic of the functional entity include a measure of an importance of I/O streams coming from the respective entity.

9. The storage system according to claim 3, wherein at least one of said functional entities is adapted to identify a group of blocks which are already stored within said NVS device and/or empty blocks which are sequentially arranged within the NVS device intermediately in-between two I/O requests which are not in sequence with one another, and wherein said functional element is adapted to form from said two I/O requests and said intermediate sequence a single of extended I/O request.

10. The storage system according to claim 4, wherein said controller is adapted to determine a size of each subframe, at least according to the priority of each of said functional entities during the given system state.

11. The storage system according to claim 4, wherein said subframes are equal in size, and said controller is adapted to determine a number of subframes to be allocated to each of said functional elements according to the priority of the respective functional element during the given system state.

12. The storage system according to claim 4, wherein said controller is responsive to an indication that the system state has changed for reallocating the subframes among said two or more functional entities according to an updated priority of said functional elements during the new system state.

13. The storage system according to claim 4, wherein one or more functional entities which generate a stream of I/O requests for accessing the NVS device are added and/or removed as the system state changes, giving rise to a new set of two or more functional entities generating a stream of I/O requests for accessing the NVS device.

14. A method of managing access to a shared storage entity, comprising:
obtaining data with respect to characteristics of each one of two or more initiator entities that share I/O access to the shared storage entity;
defining an access cycle timeframe for accessing the shared storage entity;
allocating to each one of the two or more initiators associated with the shared storage entity a continuous subframe during which the respective initiator is granted exclusive access to the shared storage entity, wherein the subframe is a continuous chunk of the access cycle timeframe; and
during each subframe locally sequencing a plurality of I/O requests on a respective one of said two or more initiator entities sharing I/O access to the shared storage entity.

15. The method according to claim 14, wherein, during each subframe the sequencing of I/O requests on a respective initiator entity sharing I/O access to the shared storage entity is done independently of a sequencing on any one of the other initiators sharing access to the shared storage entity.

16. A program storage device readable by machine, tangibly embodying a program of instructions executable by the machine to perform a method of managing access to a shared storage entity, comprising:
obtaining data with respect to characteristics of each one of two or more initiator entities that share I/O access to the shared storage entity;
defining an access cycle timeframe for accessing the shared storage entity;
allocating to each one of the two or more initiators associated with the shared storage entity a continuous subframe during which the respective initiator is granted exclusive access to the shared storage entity, wherein the subframe is a continuous chunk of the access cycle timeframe; and
during each subframe locally sequencing a plurality of I/O requests on a respective one of said two or more initiator entities sharing I/O access to the shared storage entity.

17. A computer program product comprising a computer useable medium having computer readable program code embodied therein of managing access to a shared storage entity, the computer program product comprising:
computer readable program code for causing the computer to obtain data with respect to characteristics of each one of two or more initiator entities that share I/O access to the shared storage entity;
computer readable program code for causing the computer to define an access cycle timeframe for accessing the shared storage entity;
computer readable program code for causing the computer to allocate to each one of the two or more initiators associated with the shared storage entity a continuous subframe during which the respective initiator is granted exclusive access to the shared storage entity, wherein the subframe is a continuous chunk of the access cycle timeframe; and
computer readable program code for causing the computer to locally sequence during each subframe a plurality of I/O requests on a respective one of said two or more initiator entities sharing I/O access to the shared storage entity.
